(19) United States
(12) Patent Application Publication
(10) Pub. No.: US 2007/0255940 A1
(43) Pub. Date: Nov. 1, 2007

(54) Transmitting Apparatus and Receiving Apparatus

(75) Inventor: Takafumi Ueno, Nara (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/720,119

(22) PCT Filed: Nov. 21, 2005
(86) PCT No.: PCT/JP05/21372

§ 371 Date: May 24, 2007

(30) Foreign Application Priority Data
Nov. 29, 2004 (JP) 2004-344328

(51) Int. Cl. H04L 9/00

(52) U.S. Cl. 713/150

(57) ABSTRACT

A transmitting apparatus includes an encrypting unit operable to encrypt at least one of digital audio information and digital video information to generate encrypted digital AV information, a tool generating unit operable to generate a tool required to decode the encrypted digital AV information, a tool identification information generating unit operable to generate tool identification information for identifying the tool, a selecting unit operable to select a predetermined tool from a plurality of tools, a transmitting control unit operable to output an instruction for generating the tool identification information to the tool identification information generating unit and outputting an instruction for selecting the predetermined tool to the selecting unit, and a transmitting unit operable to transmit the encrypted digital AV information, the tool identification information, and the tool.

### BACKGROUND OF THE INVENTION

1. Field of the Invention

The present invention relates to a transmitting apparatus which can safely transmit a signal including digitalized video information and digitalized audio information and a receiving apparatus which can receive the signal.

2. Description of the Related Art

FIG. 9 shows a conventional example. FIG. 9 is a block diagram showing a conventional transmitting apparatus 502 and a conventional receiving apparatus 503. In FIG. 9, the transmitting apparatus 502 includes a video encoding unit 10 conforming to MPEG-2 video (ISO/IEC13818-2) and an audio encoding unit 15 conforming to MPEG-2 audio (ISO/IEC13818-3). The receiving apparatus 503 includes a video decoding unit 106 and an audio decoding unit 111.

In FIG. 9, in the conventional transmitting apparatus 502, an input digital video signal 9 is outputted by the video encoding unit 10 as a video bitstream 11 compressed and encoded in conformity to MPEG-2 video. The input digital audio signal 14 is compressed and encoded by the audio encoding unit 15 and outputted as an audio bitstream 16.

In the receiving apparatus 503, the video bitstream 11 is expanded by the video decoding unit 106 and outputted as a digital video signal 107. The audio bitstream 16 is expanded by the audio decoding unit 111 and outputted as a digital audio signal 112.

According to the conventional technique, a method of encrypting and protecting a video bitstream or the like is not performed, and the video bitstream or the like can be easily stolen by an illegal receiving apparatus. Even if encryption is performed, a measure against illegal decryption of the encrypting method itself is not taken. More specifically, there are no means to protect against illegal reception of data transmitted by a transmitting apparatus.

### SUMMARY OF THE INVENTION

It is an object of the present invention, in consideration of the above problem, to provide a protecting unit for enabling a receiving apparatus to safely receive data transmitted from a transmitting apparatus.

The above-described problem can be solved by the following transmitting apparatus. The transmitting apparatus includes an encrypting unit operable to encrypt at least one of digital audio information and digital video information to generate encrypted digital AV information, a tool generating unit operable to generate a tool required to decrypt the encrypted digital AV information, a tool identification information generating unit operable to generate tool identification information for identifying the tool, a selecting unit operable to select a predetermined tool from a plurality of tools, a transmitting control unit operable to output an instruction for generating the tool identification information to the tool identification information generating unit and outputting an instruction for selecting the predetermined tool to the selecting unit, and a transmitting unit operable to transmit the encrypted digital AV information, the tool identification information, and the tool.

The transmitting apparatus may further include a tool list information generating unit operable to generate tool list information having the tool identification information. In this case, the transmitting control unit outputs, in place of an instruction for generating the tool identification information to the tool identification information generating unit, an instruction for generating tool list information to the tool list information generating unit. The transmitting unit can further transmit the tool list information.

The tool may include a two-way authentication tool. Furthermore, the tool may include a key management tool.

The identification information may indicate a manufacturer of a receiving apparatus. Furthermore, the identification information may indicate a transmitter. Alternatively, the identification information may indicate a manufacturer of a DRM module.

Furthermore, the transmitting unit may transmit a DRM module container including the tool identification information, an updating availability/unavailability flag indicating updating of a tool, and module version number. The transmitting unit may further transmit an ID indicating a right description method with respect to the DRM.

The transmitting apparatus may further include an invalid tool information generating unit indicating an invalid tool. In this case, the transmitting control unit instructs the invalid tool generating unit to generate an invalid tool list.

The transmitting apparatus may further include a granulating information generating unit operable to generate granulating information indicating a ratio of a tool to all the control tools.

The transmitting control unit may output an instruction for transmitting information related to a possessed tool.

The transmitting apparatus may further include a receiving unit operable to receive request information related to a tool and decryption digital AV information from a receiving apparatus. In this case, the transmitting control unit outputs an instruction for selecting the tool on the basis of the request information.

The transmitting control unit may add the invalid tool information to the tool list information on the basis of information related to an invalid tool received through the receiving unit.

Further, the above problems are solved by the following receiving apparatus. The receiving apparatus includes: a unit operable to receive encrypted digital AV information and tool identification information, the encrypted digital AV information being obtained by encrypting at least one of digital audio information and digital video information; a tool identification information separating unit operable to separate tool identification information for identifying a tool required to decode the encrypted digital AV information; an incorporating unit operable to receive and incorporate a tool specified by the tool identification information; a decoding unit operable to decode the encrypted digital AV information; a unit operable to extract the digital audio information and the digital video information from the encrypted digital AV information by using the decoding unit and the tool; and a receiving control unit operable to instruct the tool identification information separating unit to separate the tool identification information, and instruct the incorporating unit to incorporate the tool, and instruct the decoding unit to decode the encrypted digital AV information.

The receiving apparatus may include a tool list information separating unit operable to decrypt the received tool list information to extract tool identification information in place of the tool identification information separating unit. In this case, the receiving unit receives encrypted digital AV information and tool list information. The encrypted digital AV information is obtained by encrypting at least one of the digital audio information and the digital video information. Thus, the receiving control unit can instruct the tool list separating unit to extract the tool identification information.

The receiving unit can receive a DRM module container including the tool identification information, updating availability/unavailability flag indicating updating of a tool, and a module version number.

The DRM module may be received on the basis of tool identification information indicating a manufacturer of the DRM module, and the encrypted digital AV information may be decrypted by the received DRM module.

A tool may be received on the basis of tool identification information indicating a manufacturer of the receiving apparatus, and the encrypted digital AV information may be decrypted on the basis of the received tool.

Right identification information indicating a right description method with respect to the DRM may be received, and the encrypted digital AV information may be decrypted on the basis of the received right identification information.

The tool may control a built-in decrypting unit operable to decrypt the AV information.

The receiving apparatus may further include an incorporation prohibiting unit operable to prohibit the tool from being incorporated in the incorporating unit of the tool. In this case, when a tool is indicated as an invalid tool in the tool list information, the receiving control unit can prohibit the incorporation prohibiting unit from incorporating the tool.

The receiving apparatus may further include a transmitting unit operable to request a new tool to the transmitting apparatus.

The receiving control unit may instruct the transmitting apparatus to transmit information related to a possessed tool and an encryption/decryption tool.

The receiving apparatus may further include a transmitting unit operable to inform the transmitting apparatus of a manufacturer of the receiving apparatus.

The receiving apparatus may further include a transmitting unit operable to inform the transmitting apparatus of request information related to a tool and encrypted digital AV information.

As is apparent from the foregoing description, since the transmitting apparatus according to the present invention can download encrypted data as well as tool protecting information to decrypt a code, on the receiving apparatus, the transmitting apparatus can update a tool and provide convenience to make it possible to provide the latest protecting method.

In addition to the above advantage, the transmitting apparatus according to the present invention has an advantage that tool list information can be easily used as a table.

In addition to the above advantages, the transmitting apparatus according to the present invention has an advantage that it can show an invalid tool.

Since the transmitting apparatus according to the present invention can show granulating information, confusion in system establishment can be advantageously reduced.

The receiving apparatus according to the present invention can update a tool by, for example, downloading, and can advantageously keep the latest protecting method.

In addition to the above advantages, the receiving apparatus according to the present invention can obtain entire tool information based on the tool list information.

In addition to the above advantages, the receiving apparatus according to the present invention can protect an invalid tool from being incorporated in the receiving apparatus.

In addition to the above advantages, the receiving apparatus according to the present invention obtains granulating information of a tool to make it possible to establish an optimum system.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a diagram showing a schematic configuration of a transmitting apparatus according to a first embodiment of the present invention;

FIG. 2 is a diagram showing a schematic configuration of a transmitting apparatus according to a second embodiment of the present invention;

FIG. 3 is a diagram showing a schematic configuration of a transmitting apparatus according to a third embodiment of the present invention;

FIG. 4 is a diagram showing a schematic configuration of a transmitting apparatus according to a fourth embodiment of the present invention;

FIG. 5 is a diagram showing a schematic configuration of a receiving apparatus according to a fifth embodiment of the present invention;

FIG. 6 is a diagram showing a schematic configuration of a receiving apparatus according to a sixth embodiment of the present invention;

FIG. 7 is a diagram showing a schematic configuration of a receiving apparatus according to a seventh embodiment of the present invention;

FIG. 8 is a diagram showing a schematic configuration of a receiving apparatus according to an eighth embodiment of the present invention; and

FIG. 9 is a diagram showing a schematic configuration of a conventional apparatus.

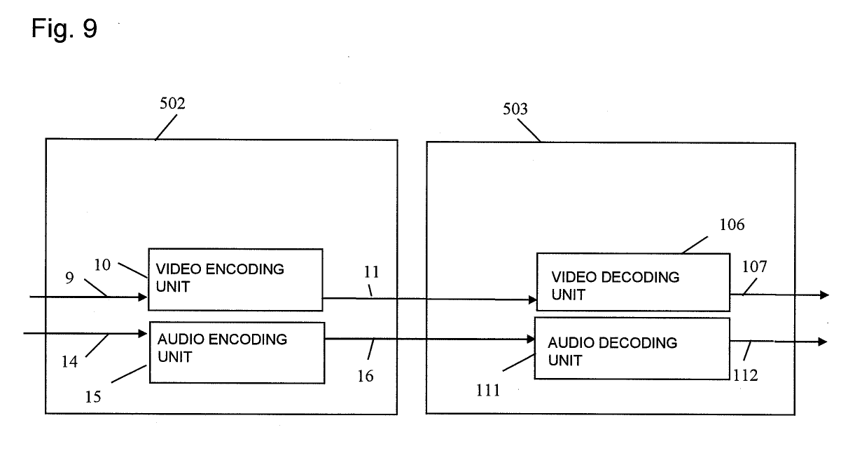

### DESCRIPTION OF THE PREFERRED EMBODIMENTS

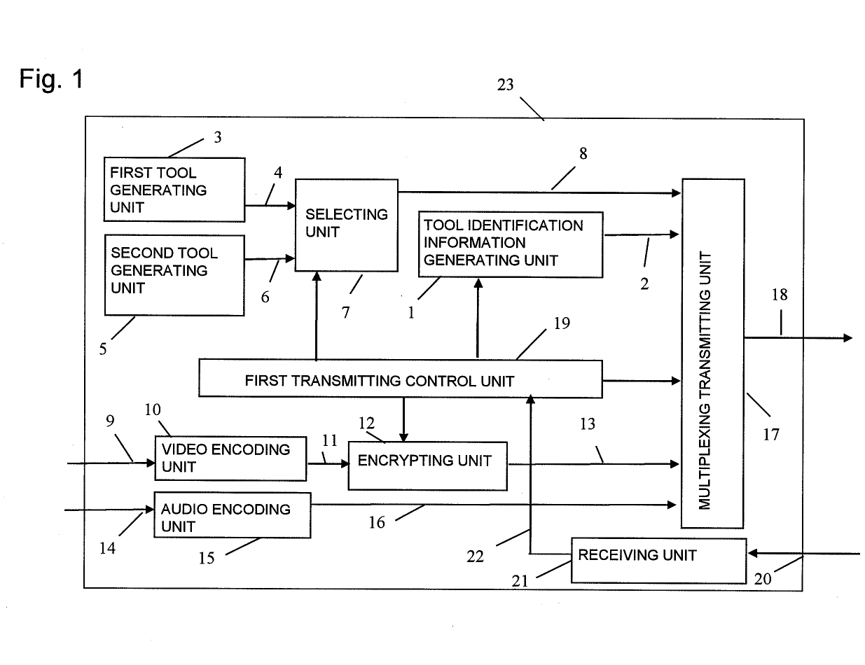

Transmitting apparatuses and receiving apparatuses according to embodiments of the present invention will be described below with reference to FIGS. 1 to 8. The same reference numerals denote substantially the same parts in the drawings.

### First Embodiment

FIG. 1 is a block diagram showing a configuration of a transmitting apparatus according to a first embodiment of the present invention. In FIG. 1, the transmitting apparatus 23 includes a tool identification information generating unit 1 which generates tool identification information 2, a first tool generating unit 3 which generates a first tool 4, a second tool generating unit 5 which generates a second tool 6, a selecting unit 7 which switches and outputs the first tool 4 and the second tool 6, an encrypting unit 12, a multiplexing transmitting unit 17, a first transmitting control unit 19, a receiving unit 21, a video encoding unit 10 conforming to MPEG-2 video (ISO/IEC13818-2), and an audio encoding unit 15 conforming to MPEG-2 audio (ISO/IEC13818-3).

In FIG. 1, an input digital video signal 9 is compressed and encoded by the video encoding unit 10 into a video bitstream 11 conforming to MPEG-2, encrypted by the encrypting unit 12, and outputted as an encrypted video bitstream 13. An input digital audio signal 14 is compressed and encoded by the audio encoding unit 15 into MPEG-2 audio data and outputted as an audio bitstream 16.

The transmitting apparatus 23 transmits the encrypted video bitstream 13 and the audio bitstream 16 to a receiving apparatus. In this case, two-way authentication, exchange of keys, and the like are performed between the transmitting apparatus 23 and the receiving apparatus to provide a tool necessary for the receiving apparatus. In this case, the tool means all control tools necessary for two-way authentication between the transmitting apparatus and the receiving apparatus, key management, and decryption. In relation to the decryption, both a decrypting unit (cipher) for decoding the encrypted video bitstream 13 in decryption and a control unit therefore are included, or only the control unit is included. Here, it is assumed that a cipher for decoding an encrypted video bitstream is built in the receiving apparatus, and the control unit is transmitted from the transmitting apparatus.

The first tool generating unit 3 outputs the first tool 4 including control tools for the two-way authentication, the key management, and decryption of AES. Similarly, the second tool generating unit 5 outputs the second tool 6 including control tools for the two-way authentication and decryption of the key management triple DES.

It is assumed that input information 20 is given by the receiving apparatus, and the receiving apparatus includes a decryption cipher which executes AES decoding. Since the receiving apparatus does not include the control unit for the decryption cipher, a case in which a control tool serving as the control unit is requested to the transmitting apparatus 23 will be described below.

The receiving unit 21 receives the input information 20 to supply a received information 22 that requests a tool including control software for AES to the first transmitting control unit 19. The first transmitting control unit 19 instructs the selecting unit 7 to select the first tool 4. In this manner, a tool 8 serves as the first tool 4.

The first transmitting control unit 19 instructs the tool identification information generating unit 1 to generate an ID for identifying the tool 8 as the first tool 4 as tool identification information. In the following Table 1, since the first tool 4 is selected as the tool 8, the tool identification information is 0x00000000. In Table 1, an ID indicating a manufacturer of the receiving apparatus is also described. In Table 1, the first tool indicates company A, and the second tool indicates company B. In this case, the manufacturer is the manufacturer of the receiving apparatus. Essentially, even though the same DRM tool is used, when receiving apparatuses are different from each other, the same tool cannot be downloaded due to a difference in e.g. application programming interfaces (API) of the receiving apparatuses. For this reason, the manufacturers of the receiving apparatuses are described. In this respect, if the difference between the receiving apparatuses is taken into account, the manufacturer may be replaced with a manufacturer of a DRM module. Furthermore, a provider who transmits data may perform service for a specific receiving apparatus. In this case, since authentication, keys and the like are different from each other, the provider can also perform service for each of the receiving apparatuses.

TABLE 1

| | Tool Identification | |
|---|---|---|
| Tool | Information | Manufacturer |
| First Tool | 0x00000000 | Company A |
| Second Tool | 0x00000001 | Company B |

The first transmitting control unit 19 instructs the multiplexing transmitting unit 17 to multiplex the encrypted video bitstream 13, the audio bitstream 16, the tool 8, and the tool identification information 2 into an MPEG-2 transport stream. In this manner, the tool identification information 2 and the tool 8 are multiplexed as program specific information, and the encrypted video bitstream 13 and the audio bitstream 16 are multiplexed as an elementary stream to be outputted as a multiplexed bitstream 18.

The first embodiment describes the case in which a video bitstream is encrypted. The same applies to a case in which an audio bitstream is encrypted or a case in which a signal obtained by multiplexing a video bitstream and an audio bitstream is encrypted.

As the tool, not only all the control tools including authentication tools, key management tools, and decryption control tools but also respective authentication tools, respective key management tools, respective decryption control tools, and the like may be independently handled. The manufacturer ID may be a DRM module.

The tool 8, the encrypted video bitstream 13, the audio bitstream 16, and the tool identification information 2 are multiplexed and included in the same bitstream to be transmitted as the bitstream. The tool 8 and the tool identification information 2 may off course be independently transmitted.

As described above, since the present invention can download tool protecting information for decrypting a code together with encrypted data, on a receiving apparatus, a tool can be updated, and the latest protecting method can be always provided.

### Second Embodiment

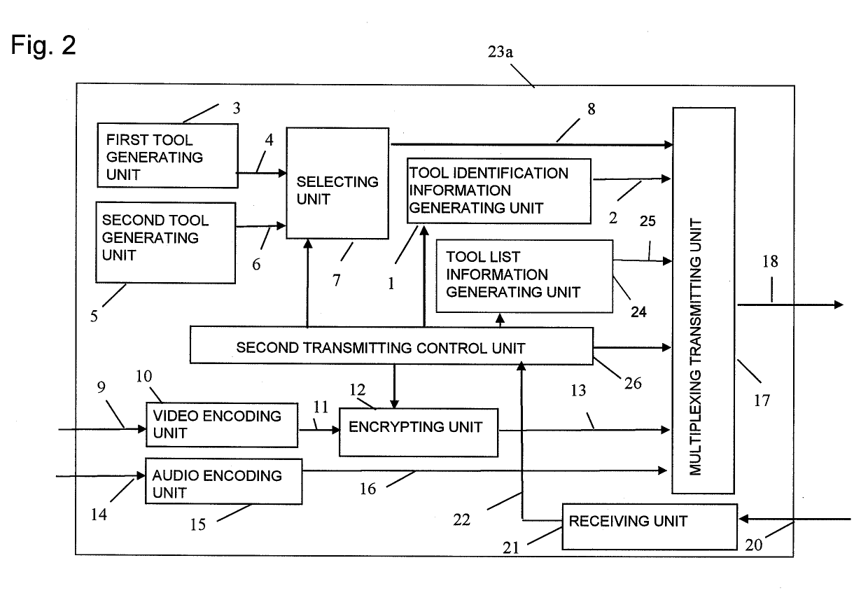

A second embodiment is similar to the first embodiment. The second and first embodiments are different in that information related to a tool is transmitted to a receiving apparatus as tool list information. FIG. 2 is a block diagram showing a configuration of a transmitting apparatus 23a according to the second embodiment. In FIG. 2, the transmitting apparatus 23a is different from the transmitting apparatus according to the first embodiment in that the transmitting apparatus 23a includes a transmitting control unit 26 in place of the first transmitting control unit and further includes a tool list information generating unit 24 which generates tool list information.

The second transmitting control unit 26 instructs the tool list information generating unit 24 to form a table listing the contents of Table 1 and generate a table as tool list information 25. In this manner, a receiving apparatus can see all tools with reference to the tool list information 25.

Other operations are the same as those in the first embodiment of the present invention.

As described above, according to the present invention, since encrypted data can be downloaded on the receiving apparatus, the tool can be updated, the latest protecting method can be always provided, and tool list information can advantageously be used easily as a table.

### Third Embodiment

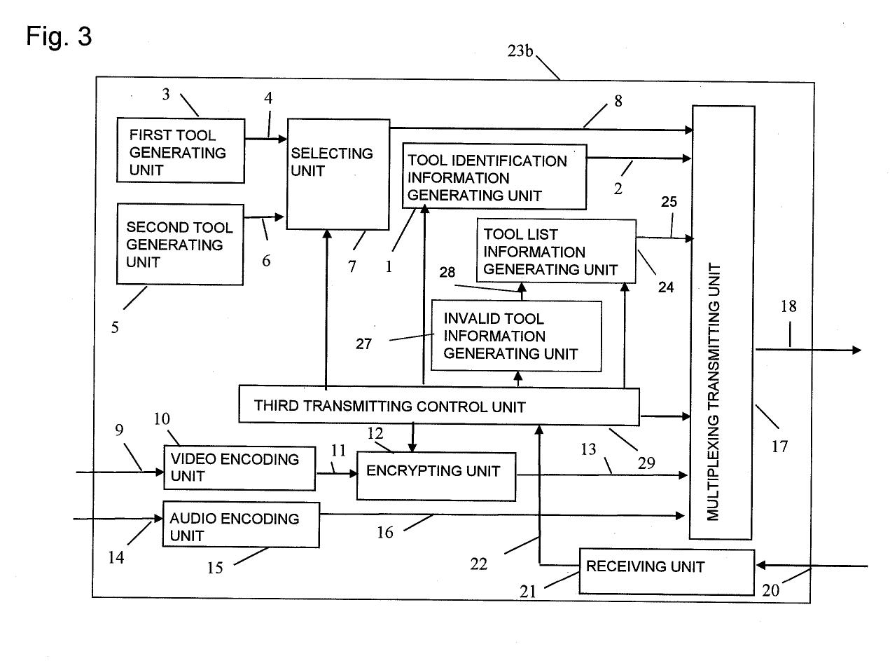

A third embodiment is a transmitting apparatus similar to that of the second embodiment. The third embodiment is different from the second embodiment in that invalid tool information is described in the tool list information. FIG. 3 is a block diagram showing a configuration of a transmitting apparatus 23b according to the third embodiment. When compared with the transmitting apparatus according to the second embodiment, the transmitting apparatus 23b includes a third transmitting control unit 29 in place of the second transmitting control unit and further includes an invalid tool information generating unit 27.

In FIG. 3, a receiving unit 21 receives input information 20 and supplies received information 22 including information that a second tool causes a bug or a failure in reliability to the third transmitting control unit 29. The third transmitting control unit 29 instructs the invalid tool information generating unit 27 to generate invalid tool information 28 which informs that the second tool is invalid and to transmits the invalid tool information 28 to the tool list information generating unit 24.

The tool list information generating unit 24 outputs tool list information 25 including the invalid tool information 28. In the tool list information, the invalid tool information 28 may be expressed by an invalid flag as shown in, for example, the following Table 2. In this manner, the transmitting apparatus 23b can inform a receiving apparatus to which the transmitting apparatus 23b transmits data that the second tool is an invalid tool.

TABLE 2

| | Tool Identification | | |
|---|---|---|---|
| Tool | Information | Manufacturer | Invalid Flag |
| First Tool | 0x00000000 | Company A | |
| Second Tool | 0x00000001 | Company B | Invalid |

In Table 2, it is shown that the second tool of Company B is invalid. Company B itself can be invalidated, as a matter of course.

In the third embodiment of the present invention, although the invalid tool information is included in the tool list information, the invalid tool information may be independently transmitted. The third embodiment may be combined with the first embodiment of the present invention.

As described above, according to the present invention, since encrypted data can be downloaded on the receiving apparatus, a tool can be updated, and the latest protecting method can be provided. The tool list information can be easily used as a table, and an invalid tool can be advantageously shown.

### Fourth Embodiment

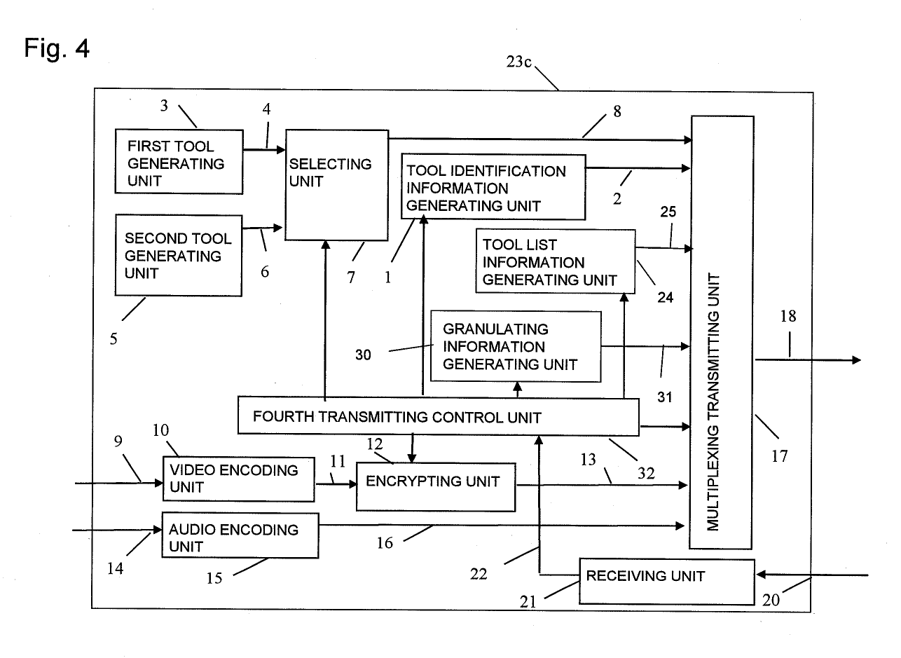

A fourth embodiment is a transmitting apparatus similar to that of the second embodiment. The fourth embodiment is different from the second embodiment in that granulating information for a tool can be transmitted. FIG. 4 is a block diagram showing a configuration of a transmitting apparatus 23c according to the fourth embodiment. The transmitting apparatus 23c is different from the transmitting apparatus according to the third embodiment in that the transmitting apparatus 23c includes a fourth transmitting control unit 32 in place of the third transmitting control unit and includes a third tool generating unit 33 in place of the second tool generating unit. Furthermore, the transmitting apparatus 23c is different from the transmitting apparatus according to the third embodiment in that the transmitting apparatus 23c further includes a granulating information generating unit 30 which generates granulating information 31 indicating a ratio of a tool 8 to all control tools.

In a transmitting/receiving system, the following cases are mixed with each other. That is, respective control tools are shown as the tool 8, or all control tools including an authentication tool, a key management tool, and the like are shown as the tool 8. In this case, when it is clearly specified that the tool represents all the control tools or the respective elements, a system which is free from confusion can be established. As an index for indicating that the tool 8 represents all the control tools or the respective control tools, the granulating information 31 is arranged.

In FIG. 4, the fourth transmitting control unit 32 instructs the granulating information generating unit 30 to generate the granulating information 31.

In the granulating information 31 shown in Table 3, since a first tool 4 means all the control tools including the authentication tool, the key management tool, and the like, a granulating level is set at 0. On the other hand, since the third tool 34 includes only a control tool for AES decryption, the granulating level is set at 1.

TABLE 3

| Tool | Granulating Information |
|---|---|
| First Tool | Level 0 |
| Third Tool | Level 1 |

In the above description, the cases are mixed to each other. If granulating information is transmitted even when the cases are not mixed with each other, confusion in system establishment can be advantageously reduced.

As described above, according to the present invention, since encrypted data can be downloaded on the receiving apparatus, a tool can be updated, and the latest protecting method can be provided. The tool list information can be easily used as a table, and confusion in system establishment can be reduced because granulating information for a tool can be shown.

### Fifth Embodiment

A fifth embodiment is a transmitting apparatus similar to those of the first to fourth embodiments. The fifth embodiment adopts another expressing form. The following Table 4 shows DRM management information multiplexed in program specific information. When the DRM management information is 01, the information indicates a DRM module container. When the DRM management information is 02, the information indicates a right container. More specifically, elements included in all the tools described in the first to fourth embodiments are classified in a DRM module and a DRM right and described.

TABLE 4

| DRM Management | |
|---|---|
| Information | Name |
| 0x00 | Prohibition |
| 0x01 | DRM Module Container Management |
| | Information |
| 0x02 | DRM Right Container Management |
| | Information |
| 0x03-0x05 | DRM Reserve |
| 0x06-0xC0 | Reserve |
| 0xC1-0xFE | User Information |
| 0XFF | Prohibition |

Table 5 shows DRM module information as a tool multiplexed in the program specific information. The DRM module information means all control tools including an authentication tool, a key management tool, and a decryption control tool. A manufacturer ID shown in Table 5 is included as a portion of a DRM module shown in Table 5.

A length means a container length. The manufacturer ID is an ID indicating a manufacturer of a DRM module or a receiving apparatus. A flag is a concept similar to granulating information described in the fourth embodiment. The flag is more simplified to indicate the presence/absence of updating of a tool by 1/0. More specifically, tools to be updated are changed depending on the degree of granulation in the fourth embodiment. In the fifth embodiment, it is determined by the flag whether the tool is updated. The manufacturer ID is an ID for identifying a DRM module that varies depending on manufacturers of receiving apparatuses or the receiving apparatuses. Although a module version number is a number of a DRM module, the module version number is a concept similar to a manufacturer of a receiving apparatus. The module version numbers are described in accordance with DRM modules which vary depending on specifications of receiving apparatus to discriminate the DRM modules from each other. The DRM module is the main body of the DRM module.

TABLE 5
DRM Module Container Management Information (0x01)

Length
Flag
Manufacturer ID
Module Version Number
DRM Module

The following Table 6 shows DRM right container information serving as a tool multiplexed in program specific information. The length means a container length. A right ID means an ID indicating a right description method. A description language means an expression language such as XML or binary. Right data is contents of a right. In this case, the right data need not be simultaneously transmitted as shown in Table 4, and the right data may be independently transmitted. For example, when the right data is possessed by the terminal side already, or when the right data is described in URL, only a right ID may be transmitted.

TABLE 6
DRM Right Container Management Information (0x02)

Length
Right ID
Description Language
Right Data

As described above, according to the present invention, since encrypted data can be downloaded on a receiving apparatus, a tool can be updated, and the latest protecting method can be always provided. An optimum system can be established by the presence/absence of updating of a tool, version information, right information, and the like.

### Sixth Embodiment

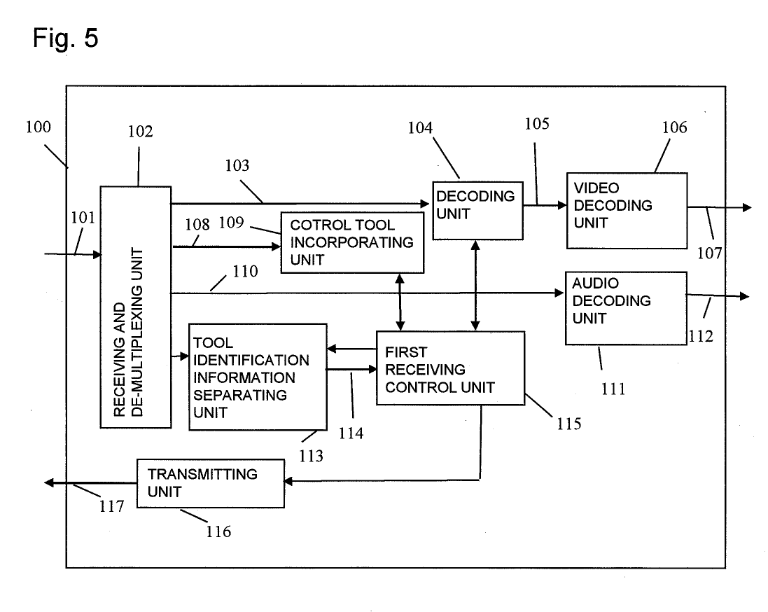

FIG. 5 is a block diagram showing a configuration of a receiving apparatus 100 according to a sixth embodiment of the present invention. The receiving apparatus 100 includes receiving and de-multiplexing unit 102, a decoding unit 104, a video decoding unit 106 which expands a compressed video bitstream, a control tool incorporating unit 109, a tool identification information separating unit 113, a first receiving control unit 115, a transmitting unit 116, a video decoding unit 106 which expands a compressed video bitstream 105, and an audio decoding unit 111. The decoding unit 104 is constituted by a decryption device (cipher) which decodes AES. The control tool incorporating unit 109 is constituted by a writable memory or the like. A control tool 108 is constituted by software in this case.

In FIG. 5, a multiplexed bitstream 101 to be inputted is added to the receiving and de-multiplexing unit 102. The receiving and de-multiplexing unit 102 de-multiplexes an encrypted video bitstream 103, an audio bitstream 110, and tool identification information from the multiplexed bitstream 101.

In this case, the tool identification information follows Table 7. More specifically, when the tool identification information is 0x00000000, the information means a first tool. When the tool identification information is 0x00000001, the information means a second tool. In Table 7, an ID indicating a manufacturer of a receiving apparatus is also described. Table 7 shows that the first tool is from Company A and that the second tool is from Company B.

TABLE 7

| | Tool Identification | |
|---|---|---|
| Tool | Information | Manufacturer |
| First Tool | 0x00000000 | Company A |
| Second Tool | 0x00000001 | Company B |

The tool identification information separating unit 113 extracts 0x000000000 indicating the first tool as the tool identification information 114 to supply to the first receiving control unit 115.

The control tool 108 is software in the present embodiment and written in the control tool incorporating unit 109 constituted by a writable memory.

The first receiving control unit 115 sequentially reads software codes from the control tool incorporating unit 109 to control the decoding unit 104. In this manner, the encrypted video bitstream 103 is decrypted, outputted as the compressed video bitstream 105, expanded by the video decoding unit 106, and outputted as a digital video signal 107.

The first receiving control unit 115 outputs, for example, manufacturer information of the receiving apparatus and built-in decryption tool information as information 117 of the receiving apparatus 100 through the transmitting unit 116. When a tool must be updated, the receiving control unit 115 requests a transmitting apparatus to update the tool. In this manner, the tool required for the receiving apparatus 100 can be updated.

As the tool, not only all control tools including authentication tools, key management tools, and decryption control tools but also respective authentication tools, respective key management tools, and respective decryption control tools may be independently handled.

The de-multiplexing unit 102 separates a tool 8, the encrypted video bitstream 13, an audio bitstream 16, and tool identification information from the same bitstream. An independently transmitted tool 8 or tool identification information may be separated.

As described above, according to the sixth embodiment of the present invention, a tool can be updated by, for example, downloading, and the latest protecting method can always be advantageously provided.

### Seventh Embodiment

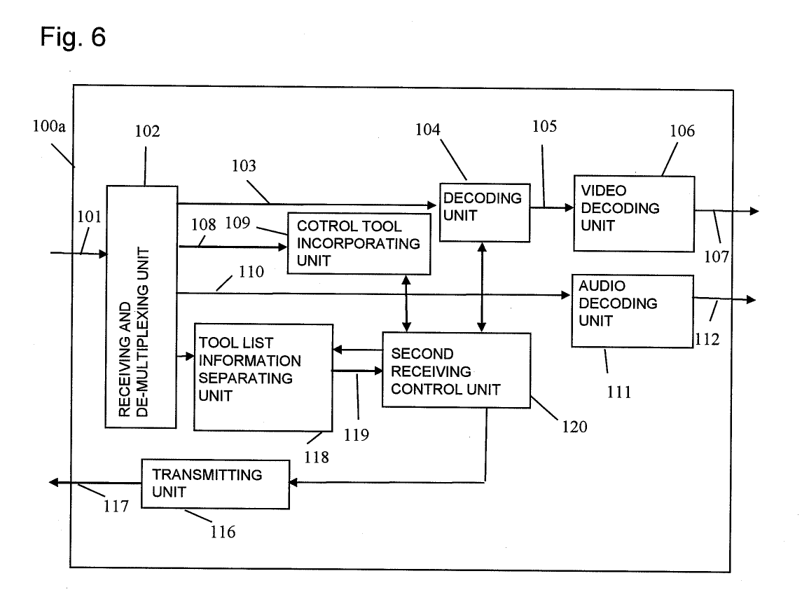

FIG. 6 is a block diagram showing a configuration of a receiving apparatus 100a according to a seventh embodiment of the present invention. In FIG. 6, the receiving apparatus 100a is different from the receiving apparatus according to the sixth embodiment in that the receiving apparatus 100a includes a second receiving control unit 120 in place of the first receiving control unit and further includes a tool list information separating unit 118 which separates tool list information 119 in place of the tool identification information separating unit.

In FIG. 6, a multiplexed bitstream 101 to be inputted is added to a receiving and de-multiplexing unit 102. The receiving and de-multiplexing unit 102 separates an encrypted video bitstream 103, an audio bitstream 110, and tool list information from the multiplexed bitstream 101.

In this case, the tool list information is obtained by expressing Table 4 in a table form. The tool list information separating unit 118 extracts 0x000000000 which expresses a first tool as the tool list information 119 to supply to the first receiving control unit 120.

A control tool 108 is software in the present embodiment and written in the control tool incorporating unit 109 constituted by a writable memory or the like.

The second receiving control unit 120 sequentially reads software codes from the control tool incorporating unit 109 to control a decoding unit 104. In this manner, the encrypted video bitstream 103 is decrypted, outputted as the compressed video bitstream 105, expanded by the video decoding unit 106, and outputted as a digital video signal 107.

The second receiving control unit 120 outputs information 117 of the receiving apparatus 100a through a transmitting unit 116. When a tool must be updated, the second receiving control unit 120 requests a transmitting apparatus to update the tool. In this manner, the tool required for the receiving apparatus 100a can be updated.

As described above, according to the seventh embodiment of the present invention, a tool can be updated by, for example, downloading, and the latest protecting method can always be advantageously provided. Furthermore, all tool information can be advantageously obtained by tool list information.

### Eighth Embodiment

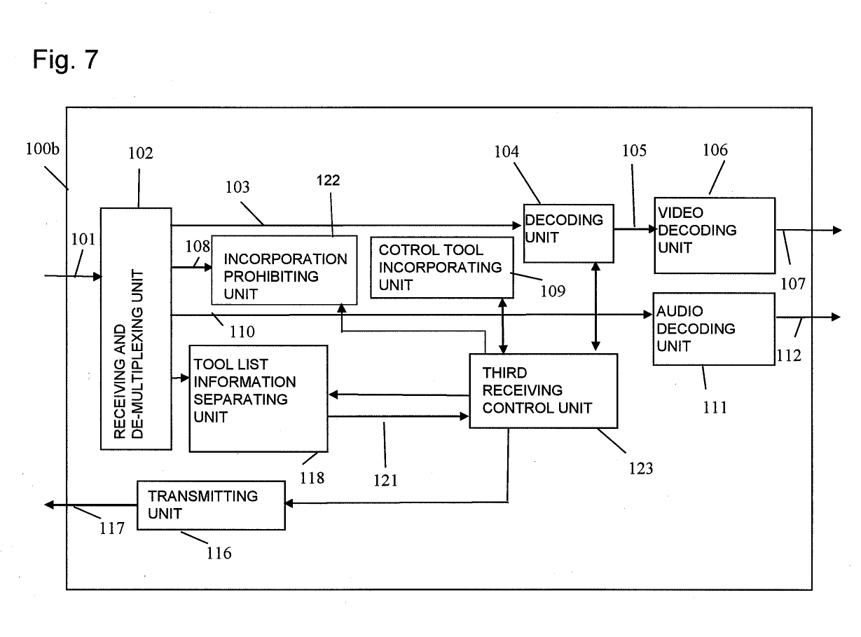

FIG. 7 is a block diagram showing a configuration of a receiving apparatus 100b according to an eighth embodiment of the present invention. In FIG. 7, the receiving apparatus 100b is different from the receiving apparatus according to the seventh embodiment in that the receiving apparatus 100b includes a third receiving control unit 123 in place of the second receiving control unit, and further includes an incorporation prohibiting unit 122.

In FIG. 7, a multiplexed bitstream 101 to be inputted is added to a receiving and de-multiplexing unit 102. The receiving and de-multiplexing unit 102 separates an encrypted video bitstream 103, an audio bitstream 110, and tool list information from the multiplexed bitstream 101.

In this case, the tool list information separating unit 118 separates tool list information shown in Table 8 and transmits invalid tool information 121 which informs that a first tool is invalid to a third receiving control unit 123.

TABLE 8

| | Tool | | |
|---|---|---|---|
| Tool | Identification Information | Manufacturer | Invalid Flag |
| First Tool | 0x00000000 | Company A | Invalid |
| Second Tool | 0x00000001 | Company B | |

The third receiving control unit 123 instructs the incorporation prohibiting unit 122 to prohibit a first control tool 108 from being incorporated in a control tool incorporating unit 109. In this manner, since the first tool defined as an invalid tool is not incorporated in the control tool incorporating unit 109, the encrypted video bitstream 103 is not decrypted. Information 117 of the receiving apparatus 100b is outputted through a transmitting unit 116. When a tool must be updated, the third receiving control unit 123 requests a transmitting apparatus to update the tool. In this manner, the tool required for the receiving apparatus 100b can be updated.

As described above, according to the eighth embodiment of the present invention, a tool can be updated by, for example, downloading, and the latest protecting method can always be provided. Furthermore, an invalid tool can be advantageously prevented from being incorporated in the receiving apparatus 100b.

### Ninth Embodiment

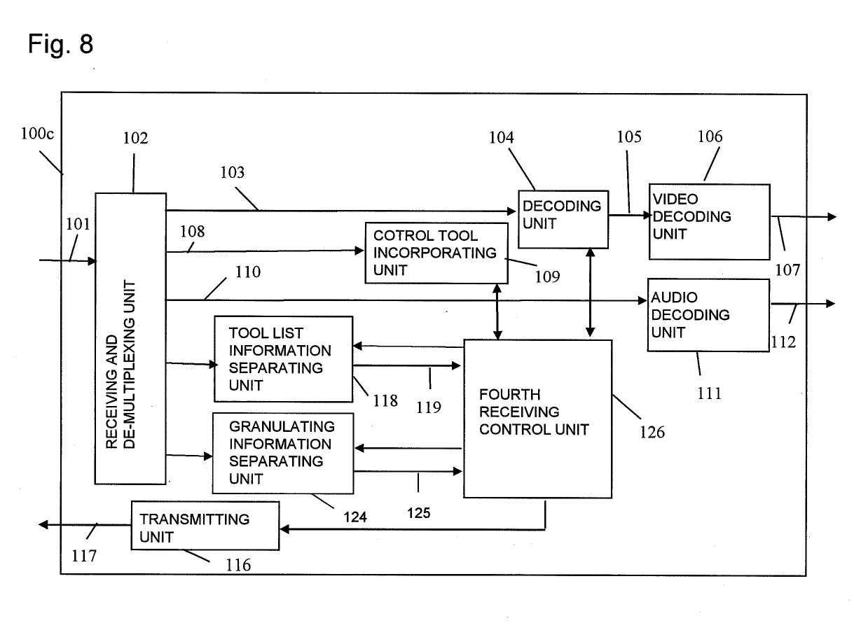

FIG. 8 is a block diagram showing a configuration of a receiving apparatus 100c according to a ninth embodiment of the present invention. In FIG. 8, the receiving apparatus 100c is different from the receiving apparatus according to the seventh embodiment in that the receiving apparatus 100c includes a fourth receiving control unit 126 in place of the second receiving control unit and further includes a granulating information separating unit 124 which separates granulating information 125.

In FIG. 8, a multiplexed bitstream 101 to be inputted is added to a receiving and de-multiplexing unit 102. The receiving and de-multiplexing unit 102 separates an encrypted video bitstream 103, an audio bitstream 110, and tool list information from the multiplexed bitstream 101.

In this case, the tool list information is obtained by expressing Table 7 in a table form. The tool list information separating unit 118 extracts 0x000000000 which expresses a first tool as a tool list information 119 to supply to the fourth receiving control unit 126. The fourth receiving control unit 126 instructs the granulating information separating unit 124 to separate the granulating information 125. The granulating information separating unit 124 separates the granulating information 125 according to the instruction.

In the granulating information 125 shown in Table 9, since a first tool means all control tools including an authentication tool, a key management tool, and the like, a granulating level is 0. Since a third tool means only a control tool for AES decryption, the granulating level is 1. Here, since the first tool is used, software serving as a control tool 108 including all the control tools such as the authentication tool and the key management tool is written in a control tool incorporating unit 109 constituted by a writable memory or the like.

TABLE 9

| Tool | Granulating Information |
|---|---|
| First Tool | Level 0 |
| Third Tool | Level 1 |

The fourth receiving control unit 126 sequentially reads software codes from the control tool incorporating unit 109 to control a decoding unit 104. In this manner, the encrypted video bitstream 103 is decrypted, outputted as the compressed video bitstream 105, expanded by the video decoding unit 106, and outputted as a digital video signal 107.

The fourth receiving control unit 126 outputs information 117 of the receiving apparatus 100c through a transmitting unit 116.

In the above description, a plurality of tools are present in a mixed manner. Even though granulating information is transmitted when the plurality of tools are not mixed, confusion in system establishment can be advantageously reduced.

As described above, according to the present invention, since encrypted data can be downloaded on the receiving apparatus, a tool can be updated, the latest protecting method can be always provided, and an optimum system can be established while obtaining tool granulating information.

### Tenth Embodiment

A tenth embodiment is a receiving apparatus similar to those of the sixth to ninth embodiments. The tenth embodiment adopts another expressing form. The following Table 10 shows DRM management information multiplexed in program specific information. When the DRM management information is 01, the information indicates a DRM module container. When the DRM management information is 02, the information indicates a right container. Table 10 shows DRM management information multiplexed in the program specific information. When the DRM management information is 01, the information indicates a DRM module container. When the DRM management information is 02, the information indicates a right container. More specifically, respective elements included in all the tools described in the sixth to ninth embodiments are classified in a DRM module and a DRM right and described.

TABLE 10

| DRM Control | |
|---|---|
| Information | Name |
| 0x00 | Prohibition |
| 0x01 | DRM Module Container Management |
| | Information |
| 0x02 | DRM Right Container Management |
| | Information |
| 0x03-0x05 | DRM Reserve |
| 0x06-0xC0 | Reserve |
| 0xC1-0xFE | User Information |
| 0xFF | Prohibition |

The following Table 11 shows DRM module information serving as a tool multiplexed in the program specific information. The DRM module information means all control tools including an authentication tool, a key management tool, and a decryption control tool.

TABLE 11
DRM Module Container Management Information (0x01)

Length
Flag
Manufacturer ID
Module Version Number
DRM Module

The length means a container length. The manufacturer ID is an ID indicating a manufacturer of a DRM module or a receiving apparatus. The flag is set at 1 when updating is possible, and set at 0 when updating is impossible. The manufacturer ID is an ID which identifies a manufacturer of a DRM module or a receiving apparatus shown in Table 11. The module version number is a number of a DRM module. The DRM module is the main body of the DRM module.

The following Table 12 shows DRM right container information serving as a tool multiplexed in program specific information. A length means a container length. A right ID means an ID indicating a right description method. A description language means an expression language such as XML or binary. Right data is contents of a right. In this case, the right data may be independently transmitted. For example, when the right data is possessed by the terminal side already, or when the right data is described in URL, right information may be received from the URL on the basis of the right ID.

TABLE 12
DRM Right Container Management Information (0x02)

Length
Right ID
Description Language
Right Data

As described above, according to the present invention, since encrypted data can be downloaded on a receiving apparatus, a tool can be updated, and the latest protecting method can be always provided. An optimum system can be established by the presence/absence of updating of a tool, version information, right information, and the like.

As described above, the present invention is described in detail by the preferred embodiments. The present invention is not limited to the embodiments, and it is apparent to a person skilled in the art that many preferable changes and modifications are possible without departing from the following scope of the invention.

1-26. (canceled)

27. A transmitting apparatus comprising:
an encrypting unit operable to encrypt at least one of digital audio information and digital video information to generate encrypted digital AV information;
a tool generating unit operable to generate a tool required to decrypt the encrypted digital AV information;
a tool identification information generating unit operable to generate tool identification information for identifying the tool;
a selecting unit operable to select a predetermined tool from a plurality of tools;
a transmitting control unit operable to output an instruction for generating the tool identification information to the tool identification information generating unit, and output an instruction for selecting the predetermined tool to the selecting unit; and
a transmitting unit operable to transmit the encrypted digital AV information, the tool identification information, and the tool.

28. A transmitting apparatus comprising:
an encrypting unit operable to encrypt at least one of digital audio information and digital video information to generate encrypted digital AV information;
a tool generating unit operable to generate a DRM module required to decode the encrypted digital AV information;
a tool identification information generating unit operable to generate tool identification information for identifying the DRM module;
a multiplexing unit operable to multiplex program specific information including DRM management information including tool identification information for identifying the DRM module, the DRM module, and at least one of an encrypted audio bit stream or an encrypted video bit stream, to output a multiplexed bit stream;
a transmitting control unit operable to output an instruction for generating tool identification information to the tool identification information generating unit; and
a transmitting unit operable to transmit the multiplexed bitstream.

29. A transmitting apparatus comprising:
an encrypting unit operable to encrypt at least one of digital audio information and digital video information to generate encrypted digital AV information;
a tool generating unit operable to generate a right container including right information of the encrypted digital AV information;
a tool identification information generating unit operable to generate tool identification information for identifying the right container;
a multiplexing unit operable to multiplex program specific information including DRM management information indicating a DRM module or a right container, the DRM module or the right container, and at least one of the encrypted audio bitstream or the encrypted video bitstream, to output a multiplexed bitstream;
a transmitting control unit operable to output an instruction for generating tool identification information to the tool identification information generating unit; and
a transmitting unit operable to transmit the multiplexed bitstream.

30. The transmitting apparatus according to claim 28,
when the DRM management information indicates a DRM module, a manufacturer ID and a module version are included as the program specific information.

31. The transmitting apparatus according to claim 28,
when the DRM management information indicates a right container, identification information indicating a right description method and right data are included as the program specific information.

32. The transmitting apparatus according to claim 27, wherein the tool includes a two-way authentication tool.

33. The transmitting apparatus according to claim 27, wherein the tool includes a key management tool.

34. The transmitting apparatus according to claim 27, wherein the tool identification information indicates a manufacturer of a receiving apparatus.

35. The transmitting apparatus according to claim 27, wherein the tool identification information indicates a transmitter.

36. The transmitting apparatus according to claim 28, wherein the tool identification information indicates a manufacturer of a DRM module.

37. The transmitting apparatus according to claim 28, wherein the transmitting unit further transmits a DRM module container including an updating availability/unavailability flag indicating updating of a tool.

38. The transmitting apparatus according to claim 27, further comprising a granulating information generating unit operable to generate granulating information indicating a ratio of a tool to all control tools.

39. The transmitting apparatus according to claim 27, wherein the transmitting control unit outputs an instruction for transmitting information related to a possessed tool.

40. The transmitting apparatus according to claim 27, further comprising:
a receiving unit operable to receive request information related to a tool and encrypted information from a receiving apparatus,
wherein the transmitting control unit outputs an instruction for selecting the tool on the basis of the request information.

41. A receiving apparatus comprising:
a unit operable to receive encrypted digital AV information and tool identification information, the encrypted digital AV information being obtained by encrypting at least one of digital audio information and digital video information;
a tool identification information separating unit operable to separate tool identification information for identifying a tool required to decode the encrypted digital AV information;
an incorporating unit operable to receive and incorporate a tool specified by the tool identification information;
a decoding unit operable to decode the encrypted digital AV information;
a unit operable to extract the digital audio information and the digital video information from the encrypted digital AV information by using the decoding unit and the tool; and
a receiving control unit operable to instruct the tool identification information separating unit to separate the tool identification information, and instruct the incorporating unit to incorporate the tool, and instruct the decoding unit to decode the encrypted digital AV information.

42. A receiving apparatus comprising:
a unit operable to receive program specific information including encrypted digital AV information obtained by encrypting at least one of digital audio information and digital video information and DRM management information serving as identification information indicating a DRM module or a right container, and a multiplexed bitstream obtained by multiplexing a DRM module which decodes the encrypted digital AV information;
an incorporating unit operable to extract the DRM management information and, when the extracted DRM management information is a DRM module, receives and incorporates the DRM module;
a decoding unit operable to decode the encrypted digital AV information by using the DRM module; and
a receiving control unit operable to extract the DRM module, and instruct the incorporating unit to incorporate the DRM module, and instruct the decoding unit to decode the encrypted digital AV information.

43. The receiving apparatus according to claim 42,
wherein the receiving control unit extracts the DRM management information and, when the extracted DRM management information is a right container, receives the right container, and instructs the decoding unit to decode the encrypted digital AV information in accordance with right information indicated by the right container.

44. The receiving apparatus according to claim 42, when the DRM management information indicates a DRM module, a manufacturer ID, a module version, and a DRM module are included as the program specific information.

45. The receiving apparatus according to claim 43, when the DRM management information indicates a right container, identification information indicating a right description method and right data are included as the program specific information.

46. The receiving apparatus according to claim 41, wherein the receiving unit further receives a DRM module container including an updating availability/unavailability flag indicating availability/unavailability of updating of a tool.

47. The receiving apparatus according to claim 41, wherein a DRM module is received on the basis of tool identification information indicating a manufacturer of a DRM module, and the encrypted digital AV information is decoded by the received DRM module.

48. The receiving apparatus according to claim 41, wherein a tool is received on the basis of tool identification information indicating a manufacturer of a receiving apparatus, and the encrypted digital AV information is decoded on the basis of the received tool.

49. The receiving apparatus according to claim 41, wherein right identification information indicating a right description method with respect to the DRM is received, and the encrypted digital AV information is decoded on the basis of the received right identification information.

50. The receiving apparatus according to claim 41, wherein the tool controls a built-in decoding unit operable to decode the encrypted digital AV information.

51. The receiving apparatus according to claim 41, further comprising a transmitting unit operable to request a new tool from a transmitting apparatus.

52. The receiving apparatus according to claim 41, wherein the receiving control unit outputs an instruction for transmitting information related to a possessed tool and an encrypting/decoding tool to a transmitting apparatus.

53. The receiving apparatus according to claim 41, further comprising a transmitting unit operable to inform a transmitting apparatus of a manufacturer of the receiving apparatus.

54. The receiving apparatus according to claim 41, further comprising a transmitting unit operable to inform a transmitting apparatus of request information related to a tool and the encrypted information.
